(19) United States
(12) Patent Application Publication
(10) Pub. No.: US 2010/0200141 A1
(43) Pub. Date: Aug. 12, 2010

(54) RUBBER COMPOSITION FOR COVERING STEEL CORD AND PNEUMATIC TIRE

(75) Inventor: Shinya Yamamoto, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/691,812

(22) Filed: Jan. 22, 2010

(30) Foreign Application Priority Data
Feb. 12, 2009 (JP) 2009-29424

(51) Int. Cl. B60C 9/02; C08K 3/22

(52) U.S. Cl. 152/527; 524/432

(57) ABSTRACT

A rubber composition for covering a steel cord is used to form a rubber-steel cord composite used as a reinforcing material of a pneumatic tire and the like. The rubber composition includes 100 parts by weight of a diene rubber, from 0.3 to 1.5 parts by weight of N-t-butyl-2-benzothiazole sulfenimide, and from 5 to 20 parts by weight of active zinc oxide having a specific surface area by nitrogen adsorption using BET method of 20 m²/g or more.

### CROSS-REFERENCE TO RELATED APPLICATIONS

This application is based upon and claims the benefit of priority from the prior Japanese Patent Application No. 2009-29424, filed on Feb. 12, 2009; the entire contents of which are incorporated herein by reference.

### BACKGROUND OF THE INVENTION

1. Field of the Invention

The present invention relates to a rubber composition for covering a steel cord. More particularly, the invention relates to a rubber composition which is preferably used to cover a steel cord in a belt, a carcass, a chafer and the like of a pneumatic tire, and a pneumatic tire using the rubber composition to cover a steel cord.

2. Background Art

In pneumatic tires, particularly radial tires, a steel cord is frequently used as a reinforcing material of a belt layer of tires for passenger cars, and belt, carcass and chafer layers of large-sized tires for trucks and buses. In a prolonging period of use of tires, it is emphasized to increase its reinforcing effect and maintain durability over a long period of time. As a result, a rubber composition for covering a steel cord is required to have excellent adhesion to a steel cord.

Compounding an organic acid metal salt with a rubber composition and compounding a methylene acceptor such as a resorcin derivative and a methylene donor such as a melamine derivative with a rubber composition are known as a method of improving adhesion between a rubber composition and a steel cord (see JP-A-2001-234140 and JP-A-2005-255709).

On the other hand, N,N-dicyclohexyl-2-benzothiazole sulfenamide (DZ), N-cyclohexyl-2-benzothiazole sulfenamide (CZ) and the like, having good adhesion performance and slow vulcanization rate are used as a vulcanization accelerator (see JP-A-2004-323662).

The steel cord is generally used in a form of a topping sheet obtained by covering both surfaces of plural steel cords arranged in parallel in a given density with rubber using a calendering apparatus for rolling a rubber. The topping sheet is rolled up on a polyethylene sheet or a cloth liner and then stored until the topping sheet is sent to a next step as an intermediate material. When the topping sheet in an unvulcanized state is stored in a long period of time, there is a problem that adhesion after vulcanization thereof is decreased due to blooming of a rubber compounding ingredient and the change in the passage of time of a covering rubber by humidity, temperature and the like. Even though temperature and humidity during storage are controlled, there is a limit on the controlling. For this reason, a rubber composition that has small change with the passage of time and can exhibit stabilized adhesion is demanded.

US2008/0060737A1 discloses that a rubber composition having compounded therewith zinc oxide in a given amount or more to sulfur content is used in a cushion rubber provided in a shoulder part between a carcass layer and a belt layer, and further discloses that fine active zinc oxide particles may be used as the zinc oxide. However, this document does not disclose the effect of improving peel force by using active zinc oxide.

### SUMMARY OF THE INVENTION

Decrease in adhesion in the case of storing a rubber-steel cord composite in an unvulcanized state can be suppressed by using N-t-butyl-2-benzothiazole sulfenimide as a vulcanization accelerator in place of the conventional N,N-dicyclohexyl-2-benzothiazol sulfenamide. Specifically, decrease in adhesion after vulcanization of a rubber-steel cord composite can be suppressed by suppressing change with the passage of time of a rubber when the rubber-steel cord composition is stored in an unvulcanized state. However, it turned out that when N-t-butyl-2-benzothiazole sulfenimide is used, there is the demerit that peel force (adhesive force) is decreased.

Accordingly, one object of the present invention is to provide a rubber composition for covering a steel cord, that can suppress change with the passage of time of a rubber when a rubber-steel cord composite used as a reinforcing material of a pneumatic tire and the like is stored in an unvulcanized state, thereby suppressing decrease in adhesion of the rubber-steel cord composite after vulcanization thereof, and further can improve peel force.

Another object of the present invention is to provide a pneumatic tire using the rubber composition for covering a steel cord.

The rubber composition for covering a steel cord according to the present invention comprises 100 parts by weight of a diene rubber, from 0.3 to 1.5 parts by weight of N-t-butyl-2-benzothiazole sulfenimide, and from 5 to 20 parts by weight of active zinc oxide having a specific surface area by nitrogen adsorption using BET method of 20 m²/g or more.

The pneumatic tire according to the present invention comprises the rubber composition for covering a steel cord, the rubber composition being used as a covering rubber of a steel cord which reinforces at least one of a belt layer, a carcass layer and a chafer layer of a tire.

According to the present invention, change with the passage of time when storing in an unvulcanized state is suppressed by using N-t-butyl-2-benzothiazole sulfenimide as a vulcanization accelerator and compounding active zinc oxide having the above given specific surface area, thereby adhesion after vulcanization can be improved, and additionally peel force can be improved. This permits to provide a pneumatic tire having excellent durability. Furthermore, storage period of a rubber-steel cord composite in an unvulcanized state can be prolonged. This can contribute to cut down on expenses such as disposal costs of materials, without deterioration of process properties and productivity.

### DETAILED DESCRIPTION OF THE INVENTION

The embodiment of the present invention is described below.

A diene rubber is used as a rubber component in the rubber composition according to the present invention. The diene rubber used includes a natural rubber (NB) and/or a diene synthetic rubber. Examples of the diene synthetic rubber used include isoprene rubber (IR), butadiene rubber (BR), styrene-butadiene rubber (SBR), chloroprene rubber (CR) and nitrile rubber (NBR). Those diene rubbers can be used alone or as mixtures of two or more thereof. Of those, a diene rubber comprising NR which is easy to crystallize by elongation and having excellent fracture properties as a main component is preferred. Specifically, NR alone or a blend comprising 60% by weight or more of NR and 40% by weight or less of a diene synthetic rubber is preferably used.

The rubber composition of the present invention uses N-t-butyl-2-benzothiazole sulfenimide (TBSI) represented by the following formula (I) as a vulcanization accelerator.

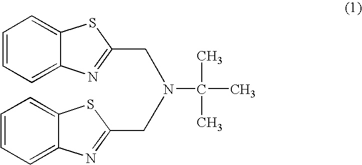

N-t-butyl-2-benzothiazole sulfenimide performs slow-acting vulcanization acceleration action and has the effect of improving stability by change with the passage of time of a rubber composition. The preferred example of N-t-butyl-2-benzothiazole sulfenimide that can be used includes SANTOCURE TBSI available from Flexsys.

The N-t-butyl-2-benzothiazole sulfenimide can be used in an amount of from 0.3 to 1.5 parts by weight per 100 parts by weight of the diene rubber component. Where the amount of N-t-butyl-2-benzothiazole sulfenimide used is less than 0.3 parts by weight, the effect of suppressing decrease in adhesion based on the change with the passage of time of a rubber-steel cord composite at the time of storage of the composite in an unvulcanized state is insufficient, and vulcanization rate is slow. On the other hand, where the amount exceeds 1.5 parts by weight, scorch properties are deteriorated, resulting in easy generation of scorching.

The rubber composition according to the present invention contains active zinc oxide (ZnO) having a specific surface area by nitrogen adsorption using BET method of 20 m²/g or more. Zinc oxide conventionally used acts as a vulcanization activator, and has a specific surface area by nitrogen adsorption using BET method of about 5 m²/g. On the other hand, fine active zinc oxide having a specific surface area of 20 m²/g or more can contribute to the improvement of adhesion (peel force). Use of the active zinc oxide can improve peel force after vulcanization while maintaining storage stability effect at the time of unvulcanization by the above inherent vulcanization accelerator. The specific surface area by nitrogen adsorption is preferably 40 m²/g or more. The upper limit of the specific surface area by nitrogen adsorption is not particularly limited, but is generally 120 m²/g or less. The specific surface area by nitrogen adsorption using BET method is measured according to JIS K6217-2.

The content of the active zinc oxide is from 5 to 20 parts by weight per 100 parts by weight of the diene rubber. Where the content is less than 5 parts by weight, the effect of improving peel force after vulcanization is insufficient. On the other hand, where the content exceeds 20 parts by weight, sufficient rubber strength is not achieved, and adhesion is deteriorated.

The rubber composition of the present invention can further comprise methylene acceptor and methylene donor. Curing reaction between a hydroxyl group of the methylene acceptor and a methylene group of the methylene donor increases adhesion between a rubber and a steel cord, and as a result, deterioration of adhesion by load and generation of heat due to tire running can be suppressed.

Examples of the methylene acceptor include phenol compounds and phenolic resins obtained by condensation of phenol compounds with formaldehyde. Examples of the phenol compounds include phenol, resorcin and their alkyl derivatives. Examples of the alkyl derivatives include methyl group derivatives such as cresol and xylenol, and derivatives by a relatively long-chain alkyl group, such as nonyl phenol and octyl phenol. The phenol compounds may contain an acyl group such as acetyl group as a substituent.

Examples of phenolic resins obtained by condensation of phenol compounds with formaldehyde include resorcin-formaldehyde resin, phenol resin (that is, phenol-formaldehyde resin), cresol resin (that is, cresol-formaldehyde resin), and formaldehyde resin comprising plural phenol compounds. Those are uncured resins, and liquid resins or resins having thermal fluidity are used.

Of those resins, from the standpoints of compatibility with a rubber component and other components, denseness of a resin after curing, and reliability, resorcin and resorcin derivatives are preferred as the methylene acceptor, and resorcin and resorcin-alkyl phenol-formalin resin are particularly preferably used.

The amount of those methylene acceptors compounded is preferably from 1 to 10 parts by weight, and more preferably from 1 to 4 parts by weight, per 100 parts by weight of the diene rubber.

Examples of the methylene donor used include hexamethylene tetramine and melamine derivatives. Examples of the melamine derivatives used include methylol melamine, a partially etherified product of methylol melamine, and a condensate of melamine, formaldehyde and methanol. Of those, hexamethoxymethyl melamine is particularly preferably used.

The amount of the methylene donor added is preferably from 0.2 to 20 parts by weight, and more preferably from 1 to 8 parts by weight, per 100 parts by weight of the diene rubber.

The rubber composition according to the present invention may contain an organic acid metal salt. Examples of the organic acid metal salt include organic acid cobalt salts such as cobalt naphthenate, cobalt stearate, cobalt oleate, cobalt neodecanate, cobalt rosinate, cobalt borate and cobalt maleate, organic acid nickel salts, and organic acid molybdenum salts. Of those, cobalt naphthenate and cobalt stearate are particularly preferred from processability.

The amount of the organic acid metal salt added is from 0.03 to 1.0 part by weight in terms of a metal content per 100 parts by weight of the diene rubber. Where the amount is less than 0.03 parts by weight, the effect of improving initial adhesion is small. On the other hand, the amount exceeds 1.0 part by weight, vulcanization rate is fast, and initial adhesion is deteriorated. Furthermore, oxidation acceleration action is increased, and heat and humidity aged adhesion and heat aging resistance are decreased.

The rubber composition according to the present invention can contain fillers such as carbon black and silica as a reinforcing agent.

The carbon black used is not particularly limited. For example, carbon black of SAF, ISAF, HAF and FEF grades can be used. Those may be used as mixtures of two or more thereof. The amount of carbon black added is not particularly limited, but is preferably from 20 to 100 parts by weight, and more preferably from 40 to 80 parts by weight, per 100 parts by weight of the diene rubber.

Examples of the silica used include wet silica (hydrous silicic acid), dry silica (anhydrous silicic acid) and surface-treated silica. When silica is added, the amount of the silica added is not particularly limited, but is preferably 40 parts by weight or less, and more preferably 20 parts by weight or less, per 100 parts by weight of the diene rubber.

The rubber composition according to the present invention generally contains sulfur as a vulcanizing agent. The amount of sulfur contained is preferably from 1 to 10 parts by weight, and more preferably from 2 to 8 parts by weight, per 100 parts by weight of the diene rubber. The sulfur is not particularly limited. Examples of the sulfur include powdered sulfur, precipitated sulfur, colloidal sulfur, insoluble sulfur and oil-treated sulfur.

In the rubber composition of the present invention, N-t-butyl-2-benzothiazole sulfenimide may be used alone as a vulcanization accelerator, and may be used together with other vulcanization accelerator. The other vulcanization accelerator used together is not particularly limited, and includes a sulfenamide vulcanization accelerator.

When N-t-butyl-2-benzothiazole sulfenimide is used together with the sulfenamide vulcanization accelerator, the total amount of the vulcanization accelerators is preferably from 0.5 to 1.5 parts by weight per 100 parts by weight of the rubber component. Where the total amount exceeds 1.5 parts by weight, scorching is generated in a rubber processing step or during storage, and vulcanization rate becomes fast. As a result, a reaction layer on a plating surface is formed in large thickness, and this may adversely affect heat and humidity aged adhesion. Furthermore, in this case, the content of N-t-butyl-2-benzothiazole sulfenimide is preferably 50% by weight or more based on the total weight of N-t-butyl-2-benzothiazole sulfenimide and the sulfenamide vulcanization accelerator. Where the content of the sulfenamide vulcanization accelerator is too large, the effect of suppressing decrease in adhesion during storage is decreased.

Examples of the sulfenamide vulcanization accelerator include N-cyclohexyl-2-benzothiazole sulfenamide (CZ, JIS abbreviation: CBS), N-tert-butyl-2-benzothiazolesulfenamide (NS, JIS abbreviation: BBS), N-oxydiethylene-2-benzothiazole sulfenamide (OBS), N,N-diisopropyl-2-benzothiazole sulfenamide (DPBS), and N,N-dicyclohexyl-2-benzothiazole sulfenamide (DZ, JIS abbreviation: DCBS).

The rubber composition according to the present invention can optionally contain various compounding ingredients generally added to a rubber composition for covering a steel cord, other than the above each component. Examples of the compounding ingredients include stearic acid, wax, oil, age resister, and processing aid. The compounding ingredients can appropriately be added so long as the object of the present invention is not violated.

The rubber composition of the present invention can be prepared by kneading the necessary components using a mixing machine generally used, such as Banbury mixer and kneader, and can be used as a rubber composition for covering various steel cords. In particular, the rubber composition of the present invention is preferably used as a covering (topping) rubber of a steel cord used as a reinforcing material of a belt layer, a carcass layer, a chafer layer and the like of a pneumatic tire. A steel cord topping sheet is produced with the rubber composition by a topping apparatus such as steel calender according to the conventional method. Using the steel cord topping sheet as a tire reinforcing material, molding and vulcanization are conducted according to the conventional method. Thus, a pneumatic radial tire can be produced.

### Examples

The present invention is described in further detail by reference to Examples, but the invention is not limited to those Examples.

According to the formulation shown in Table 1 below, each rubber composition of Examples and Comparative Examples was kneaded and prepared according to the conventional method using a closed Banbury mixer. The detail of each component in Table 1 is as follows.

Natural rubber: RSS#3

Carbon black: HAF, SEAST 300, manufactured by Tokai Carbon Co., Ltd.

Age resister: SANTOFLEX 6PPD, manufactured by Flexsys

Cobalt stearate: Cobalt stearate (Co content: 9.5% by weight), manufactured by Japan Energy Corporation

Phenolic resin: Resolcin-alkyl phenol-formalin resin, SUMIKANOL 620, manufactured by Taoka Chemical Co., Ltd.

Hexamethoxymethyl melamine: CYREZ 963L, manufactured by Nihon Cytec Industries Inc.

Zinc white #3: Zinc White #3 (specific surface area by nitrogen adsorption using BET method=5 m²/g), manufactured by Mitsui Mining & Smelting Co., Ltd.)

Active zinc oxide A: METAZ-102 (specific surface area by nitrogen adsorption using BET method=25 m²/g), manufactured by Inoue Calcium Corporation

Active zinc oxide B: Zinkoxyd aktiv (specific surface area by nitrogen adsorption using BET method=45 m²/g), manufactured by Lanxess K.K.

Active zinc oxide C: AZO (specific surface area by nitrogen adsorption using BET method=60 m²/g), manufactured by Seido Chemical Industry Co., Ltd.

Insoluble sulfur: MU-CRON HS OT-20 (sulfur content: 80% by weight), manufactured by Flexsys

Vulcanization accelerator DZ: N,N-dicyclohexyl-2-benzothiazole sulfenamide, NOCCELER DZ-G, manufactured by Ouchi Shinko Chemical Industrial Co., Ltd.

Vulcanization accelerator NS: N-t-butyl-2-benzothiazole sulfenamide, NOCCELER NS-P, manufactured by Ouchi Shinko Chemical Industrial Co., Ltd.

Vulcanization accelerator TBSI: N-t-butyl-2-benzothiazole sulfenimide, SANTOCURE TBSI, manufactured by Flexsys

An unvulcanized sample of a rubber-steel cord composite was prepared using each rubber composition obtained.

In detail, steel cords for belt (3×0.20+6×0.35 mm structure, copper/zinc=64/36, brass plating of deposition amount 5 g/kg) were arranged in parallel in a density of 12/25 mm, and both surfaces of the resulting assembly were covered with a rubber sheet having a thickness of 1 mm comprising the above each rubber composition. Two products thus obtained were laminated such that cords become parallel, and an unvulcanized sample for peel and adhesion tests was prepared. Using the unvulcanized sample obtained, initial adhesion, initial peel force, and adhesion after storage in an unvulcanized state were evaluated by the following methods. The results obtained are shown in Table 1.

### Initial Adhesion

The unvulcanized sample prepared above was allowed to stand at room temperature for 24 hours, and then vulcanized under the conditions of 150° C. and 30 minutes. The sample thus vulcanized was subjected to a peeling test between two steel cord layers using Autograph DCS 500, manufactured by Shimadzu Corporation. Rubber coverage of a steel cord after peeling was visually observed, and evaluated by 0 to 100%. Initial adhesion is good as the value is large.

### Initial Peel Force

Average peel force per 25 mm width at the time of measurement of the initial adhesion was obtained, and represented by an index as the value of Comparative Example 1 being 100. The peel force is high and good as the value is large.

Adhesion after Storage in Unvulcanized State

The unvulcanized sample prepared above was allowed to stand in a constant temperature and humidity chamber of 40° C. and 95% RH for 7 days, and then vulcanized under the conditions of 150° C. and 30 minutes. The same peeling test as above was conducted using Autograph DCS 500, manufactured by Shimadzu Corporation, and rubber coverage of a steel cord after peeling was visually observed. Adhesion stability at the time of storage in an unvulcanized state is good as the value is large.

The results obtained are shown in Table 1. In Comparative Example 3, by using TBSI as a vulcanization accelerator, adhesion stability at the time of storage in an unvulcanized state was improved as compared with Comparative Example 1 using DZ and Comparative Example 2 using NS, but initial peel force was decreased as compared with Comparative Example 1.

Regarding zinc oxide, in Comparative Examples 4 and 5 in which active zinc oxide was used in place of the conventional Zinc White #3 and DZ and NS were used as a vulcanization accelerator, the effect of improving initial peel force was recognized, but adhesion stability at the time of storage in an unvulcanized state was not improved.

On the other hand, in Examples 1 to 5 in which TBSI as a vulcanization accelerator and active zinc oxide were used in combination, initial peel force could greatly be improved while maintaining initial adhesion and further while improving adhesion stability at the time of storage in an unvulcanized state, as compared with Comparative Example 1.

TABLE 1

| | | Comparative | Comparative | Comparative | Comparative | Comparative |
|---|---|---|---|---|---|---|
| | | Example 1 | Example 2 | Example 3 | Example 4 | Example 5 |
| Formulation | Natural rubber | 100 | 100 | 100 | 100 | 100 |
| (parts by weigh) | Carbon black HAF | 60 | 60 | 60 | 60 | 60 |
| | Age resister | 2.0 | 2.0 | 2.0 | 2.0 | 2.0 |
| | Cobalt stearate(*) | 2.0 | 2.0 | 2.0 | 2.0 | 2.0 |
| | | (0.19) | (0.19) | (0.19) | (0.19) | (0.19) |
| | Phenolic resin | 2.0 | 2.0 | 2.0 | 2.0 | 2.0 |
| | Hexamethoxymethyl melamine | 4.0 | 4.0 | 4.0 | 4.0 | 4.0 |
| | Zinc White #3 (BET = 5 m²/g) | 8.0 | 8.0 | 8.0 | | |
| | Active zinc oxide A (BET = 25 m²/g) | | | | | |
| | Active zinc oxide B (BET = 45 m²/g) | | | | 8.0 | 8.0 |
| | Active zinc oxide C (BET = 60 m²/g) | | | | | |
| | Insoluble sulfur | 6.0 | 6.0 | 6.0 | 6.0 | 6.0 |
| | Vulcanization accelerator DZ | 1.0 | | | 1.0 | |
| | Vulcanization accelerator NS | | 1.0 | | | 1.0 |
| | Vulcanization accelerator TBSI | | | 1.0 | | |

| | | | | | |
|---|---|---|---|---|---|
| Initial adhesion (%) | 100 | 80 | 90 | 100 | 85 |
| Initial peel force (Index) | 100 | 86 | 85 | 112 | 96 |
| Adhesion after storage in unvulcanized | 60 | 40 | 80 | 65 | 45 |
| state (%) | | | | | |

| | | Example 1 | Example 2 | Example 3 | Example 4 | Example 5 |
|---|---|---|---|---|---|---|
| Formulation (parts by weigh) | Natural rubber | 100 | 100 | 100 | 100 | 100 |
| | Carbon black HAF | 60 | 60 | 60 | 60 | 60 |
| | Age resister | 2.0 | 2.0 | 2.0 | 2.0 | 2.0 |
| | Cobalt stearate(*) | 2.0 | 2.0 | 2.0 | 2.0 | 2.0 |
| | | (0.19) | (9.19) | (0.19) | (0.19) | (0.19) |
| | Phenolic resin | 2.0 | 2.0 | 2.0 | 2.0 | 2.0 |
| | Hexamethoxymethyl melamine | 4.0 | 4.0 | 4.0 | 4.0 | 4.0 |
| | Zinc White #3 (BET = 5 m²/g) | | | | | |
| | Active zinc oxide A (BET = 25 m²/g) | 8.0 | | | | |
| | Active zinc oxide B (BET = 45 m²/g) | | 8.0 | | 16.0 | 8.0 |
| | Active zinc oxide C (BET = 60 m²/g) | | | 8.0 | | |
| | Insoluble sulfur | 6.0 | 6.0 | 6.0 | 6.0 | 6.0 |
| | Vulcanization accelerator DZ | | | | | |
| | Vulcanization accelerator NS | | | | | |
| | Vulcanization accelerator TBSI | 1.0 | 1.0 | 1.0 | 1.0 | 0.5 |

| | | | | | |
|---|---|---|---|---|---|
| Initial adhesion (%) | 100 | 100 | 100 | 100 | 100 |
| Initial peel force (Index) | 112 | 120 | 129 | 122 | 114 |
| Adhesion after storage in unvulcanized | 85 | 90 | 95 | 95 | 85 |
| state (%) | | | | | |

(*)Amount in terms of cobalt

The rubber composition for covering a steel cord of the present invention is useful as a rubber for covering a steel cord which is a reinforcing material of a pneumatic tire, and a rubber-steel cord composite using the rubber composition can be used in a belt layer of tires for passenger cars, and belt, carcass and chafer layers of large-sized tires for trucks, buses and the like.

What is claimed is:

1. A rubber composition for covering a steel cord comprising 100 parts by weight of a diene rubber, from 0.3 to 1.5 parts by weight of N-t-butyl-2-benzothiazole sulfenimide, and from 5 to 20 parts by weight of active zinc oxide having a specific surface area by nitrogen adsorption using BET method of 20 m²/g or more.

2. The rubber composition for covering a steel cord according to claim 1, further comprising from 1 to 10 parts by weight of methylene acceptor, from 0.2 to 20 parts by weight of methylene donor, and from 0.03 to 1.0 parts by weight of an organic acid metal salt in terms of a metal content, per 100 parts by weight of the diene rubber.

3. The rubber composition for covering a steel cord according to claim 1, further comprising from 1 to 10 parts by weight of sulfur per 100 parts by weight of the diene rubber.

4. The rubber composition for covering a steel cord according to claim 1, wherein the active zinc oxide has a specific surface area by nitrogen adsorption using BET method of from 40 to 120 m²/g.

5. The rubber composition for covering a steel cord according to claim 2, wherein the methylene acceptor is at least one selected from phenol compounds, and phenolic resins obtained by condensation of the phenol compounds with formaldehyde, and the methylene donor is at least one selected from hexamethylene tetramine and melamine derivatives.

6. The rubber composition for covering a steel cord according to claim 2, wherein the organic acid metal salt is organic acid cobalt.

7. A pneumatic tire comprising the rubber composition for covering a steel cord according to claim 1, the rubber composition being used in a covering rubber of a steel cord which reinforces at least one of a belt layer, a carcass layer and a chafer layer of a tire.
